(19) United States
(12) Patent Application Publication
(10) Pub. No.: US 2026/0302117 A1
(43) Pub. Date: Oct. 1, 2026

(54) DIRECT CURRENT CONTACTOR

(71) Applicant: Kunshan GLVAC YuanTong New Energy Technology Co., Ltd., Suzhou (CN)

(72) Inventors: Chunpeng GU, Suzhou (CN); Xiaoming GUO, Suzhou (CN); Jifan YANG, Suzhou (CN)

(73) Assignee: Kunshan GLVAC YuanTong New Energy Technology Co., Ltd., Suzhou (CN)

(21) Appl. No.: 19/306,111

(22) Filed: Aug. 21, 2025

(30) Foreign Application Priority Data
Mar. 25, 2025 (CN) 202510359418.X

(51) Int. Cl. H01H 50/64; H01H 50/16; H01H 50/54

(52) U.S. Cl. CPC H01H 50/641; H01H 50/16; H01H 50/546

(57) ABSTRACT

A DC contactor includes a magnetic pole piece, a pushing rod assembly penetrating through the magnetic pole piece, and a movable contact plate mounted on the pushing rod assembly. The pushing rod assembly is configured to drive the movable contact plate to move for making or breaking contact of the DC contactor. The magnetic pole piece is provided with a first limiting structure; the pushing rod assembly is provided with a second limiting structure; and the first limiting structure and the second limiting structure cooperate to restrict rotational movement of the pushing rod assembly. The present disclosure restricts rotational degrees of freedom of the pushing rod assembly through cooperative interaction between the first limiting structure disposed on the magnetic pole piece and the second limiting structure disposed on the pushing rod assembly.

### CROSS-REFERENCE TO RELATED APPLICATIONS

This application claims priority to Chinese Patent Application No. 202510359418.X filed on Mar. 25, 2025, the content of which is incorporated herein by reference in its entirety.

### TECHNICAL FIELD

The present disclosure relates to the technical field of contactors, specifically to a Direct Current (DC) contactor.

### BACKGROUND

A DC contactor achieves making and breaking functions by driving a movable contact plate into contact with or separation from fixed contacts via a push rod portion. Within the DC contactor, the push rod portion is typically rotatable. Without constraint of its rotational degrees of freedom, rotation of the push rod portion may cause the movable contact plate to deviate from the fixed contacts. Such deviation results in failure of the movable contact plate to contact the fixed contacts, leading to malfunction of the making/breaking function. Therefore, a push rod limiting structure must be designed into the DC contactor to restrict rotation of the push rod portion.

Currently, the prior art predominantly employs two types of limiting structures. The first type utilizes ceramic ribs disposed inside a ceramic cover to provide limitation via cooperation with protrusions on a contact holder of the push rod portion. The second type relies on direct limitation between ceramic ribs and the movable contact plate. Both of the aforementioned limiting structures exhibit drawbacks including difficulties in ceramic molding, excessive occupation of internal space within the ceramic cover resulting in constrained arcing space, and restricted short-circuit space. Accordingly, improvement upon the prior art is necessary to overcome these deficiencies.

### SUMMARY

The technical problem addressed by the present disclosure is to provide a DC contactor overcoming deficiencies of conventional DC contactor limiting structures, including difficulties in ceramic molding, excessive occupation of internal space within the ceramic cover resulting in constrained arcing space, and restricted short-circuit space.

To resolve this technical problem, the present disclosure adopts the following technical solution: a DC contactor, comprising a magnetic pole piece, a pushing rod assembly penetrating through the magnetic pole piece, and a movable contact plate mounted on the pushing rod assembly; wherein the pushing rod assembly is configured to drive the movable contact plate to move for making or breaking contact of the DC contactor; wherein the magnetic pole piece is provided with a first limiting structure; the pushing rod assembly is provided with a second limiting structure; and the first limiting structure and the second limiting structure cooperate to restrict rotational movement of the pushing rod assembly.

As a further improvement of the present disclosure, the first limiting structure is fixedly and vertically disposed on the magnetic pole piece, and adjacent to the second limiting structure; and when the pushing rod assembly tends to rotate clockwise or counterclockwise, the first limiting structure and the second limiting structure mutually abut to restrict the rotational movement of the pushing rod assembly.

As a further improvement of the present disclosure, a height of the first limiting structure is such that: throughout a movement stroke of the pushing rod assembly, the second limiting structure continuously forms a limiting engagement with the first limiting structure.

As a further improvement of the present disclosure, the pushing rod assembly comprises an insulating base; and the second limiting structure is fixed to the insulating base.

As a further improvement of the present disclosure, the first limiting structure is fixed to the magnetic pole piece by welding, riveting or threaded fastening; and the second limiting structure is fixed to the insulating base by any one of integral molding, plug-in connection, riveting or using a fastener.

As a further improvement of the present disclosure, one of the first limiting structure and the second limiting structure comprises at least one limiting member; and another of the first limiting structure and the second limiting structure comprises at least two limiting portions distributed on two sides of the at least one limiting member.

As a further improvement of the present disclosure, the first limiting structure comprises a limiting member; the magnetic pole piece is provided with a stepped hole having a small-diameter upper section and a large-diameter lower section; one end of the limiting member extends upward through the stepped hole to protrude above the magnetic pole piece; another end of the limiting member is hermetically fixed within the stepped hole; the second limiting structure comprises two integrally formed or separate limiting portions; the two limiting portions protrude outward from the insulating base and are spaced apart side by side; and the limiting member is located between the two limiting portions.

As a further improvement of the present disclosure, the another end of the limiting member is provided with a soldering pad portion, and the soldering pad portion is hermetically fixed within the stepped hole by brazing or laser welding; or the soldering pad portion is covered with a sealing cover, and the sealing cover is hermetically fixed within the stepped hole by brazing or laser welding.

As a further improvement of the present disclosure, the first limiting structure comprises at least one limiting seat and at least two limiting portions fixedly disposed on the limiting seat; the limiting seat is provided with a first through hole; a top of the magnetic pole piece is provided with a first boss, and the first boss is inserted into the first through hole and riveted in place; the second limiting structure comprises at least one limiting member; and the limiting member is located between the two limiting portions.

As a further improvement of the present disclosure, the DC contactor further comprising an armature bracket, wherein the armature bracket is fixed to a top of the magnetic pole piece and overlies an outer side of the pushing rod assembly; the armature bracket is provided with a support leg, and the support leg serves as the first limiting structure; the second limiting structure comprises a limiting member adjacent to the support leg; and the limiting member cooperates with the support leg to form rotational limitation.

The beneficial effects of the present disclosure are as follows. The present disclosure provides a DC contactor, wherein rotational degrees of freedom of the pushing rod assembly are restricted through cooperative interaction between the first limiting structure disposed on the magnetic pole piece and the second limiting structure disposed on the pushing rod assembly. This configuration ensures accurate relative positioning between the movable contact plate and the fixed contact, guaranteeing reliable making and breaking functionality of the DC contactor. The present disclosure abandons conventional approaches providing ceramic ribs within the ceramic cover, thereby avoiding molding difficulties associated with ceramic ribs. This reduces manufacturing process complexity, enhances production efficiency, and improves product yield. Since reliance on ceramic ribs for limitation is eliminated, occupation of internal space within the ceramic cover is significantly reduced. Consequently, the ceramic cover retains ample internal space for arcing and short-circuit protection, enhancing electrical performance reliability of the DC contactor and reducing occurrence risk of arc-related and short-circuit failures. Furthermore, the limiting structure adopted by the present disclosure is not restricted by ceramic molding processes, affording greater design flexibility to better accommodate DC contactors of varying specifications and performance requirements.

### BRIEF DESCRIPTION OF THE DRAWINGS

To describe technical solutions in embodiments of the present disclosure more clearly, the following briefly introduces accompanying drawings required for describing the embodiments. Obviously, the drawings in the following description merely represent some embodiments of the present disclosure. Persons of ordinary skill in the art may derive other drawings from these accompanying drawings without creative efforts. In the drawings:

FIG. 1 is a perspective view of a magnetic pole piece, a pushing rod assembly, and a movable contact plate according to Embodiment 1 of the DC contactor of the present disclosure;

FIG. 2 is a cross-sectional view of the magnetic pole piece, the pushing rod assembly, and the movable contact plate according to Embodiment 1 of the DC contactor of the present disclosure;

FIG. 3 is an enlarged view of portion A in FIG. 2 of the DC contactor of the present disclosure;

FIG. 4 is an exploded view of the pushing rod assembly and the movable contact plate according to Embodiment 1 of the DC contactor of the present disclosure;

FIG. 5 is a perspective view of a magnetic pole piece, a pushing rod assembly, and a movable contact plate according to Embodiment 2 of the DC contactor of the present disclosure;

FIG. 6 is an enlarged view of portion B in FIG. 5 of the DC contactor of the present disclosure;

FIG. 7 is a perspective view of a magnetic pole piece, a pushing rod assembly, and a movable contact plate according to Embodiment 3 of the DC contactor of the present disclosure;

FIG. 8 is an enlarged view of portion C in FIG. 7 of the DC contactor of the present disclosure;

FIG. 9 is a perspective view of a magnetic pole piece, a pushing rod assembly, a movable contact plate, and an anti-short-circuit structure according to Embodiment 4 of the DC contactor of the present disclosure;

FIG. 10 is a top view showing two mounting modes of an insulating base and a limiting member according to Embodiment 4 of the DC contactor of the present disclosure;

FIG. 11 is a perspective view of a magnetic pole piece, a pushing rod assembly, and a movable contact plate according to Embodiment 5 of the DC contactor of the present disclosure;

FIG. 12 is a perspective view of a magnetic pole piece, a pushing rod assembly, a movable contact plate, and an anti-short-circuit structure according to Embodiment 6 of the DC contactor of the present disclosure; and

FIG. 13 is a perspective view of a magnetic pole piece, a pushing rod assembly, and a movable contact plate according to Embodiment 7 of the DC contactor of the present disclosure.

### DETAILED DESCRIPTION OF THE EMBODIMENTS

The present disclosure is described in detail below with reference to the accompanying drawings and specific embodiments.

The following describes embodiments of the present disclosure through specific examples. Persons skilled in the art may readily appreciate other advantages and efficacies of the present disclosure from the content disclosed in this specification. Evidently, the described embodiments represent only a portion of the embodiments of the present disclosure, not all embodiments. The present disclosure may also be implemented or applied through different specific embodiments. Various details in this specification may undergo modifications or alterations based on different perspectives and applications without departing from the spirit of the present disclosure. It should be noted that, in the absence of conflict, features in the following embodiments and examples may be combined with each other. Based on the embodiments of the present disclosure, all other embodiments obtained by persons of ordinary skill in the art without creative efforts shall fall within the scope of protection of the present disclosure.

It should be noted that the following describes various aspects of embodiments falling within the scope of the appended claims. It will be apparent that the aspects described herein may be embodied in a wide variety of forms. Any specific structure and/or function described herein is merely illustrative. Based on the present disclosure, persons skilled in the art should understand that one aspect described herein may be implemented independently of any other aspect. Two or more of these aspects may be combined in various ways. For example, equipment may be implemented and/or methods may be practiced using any number and aspects set forth herein. Additionally, this equipment may be implemented and/or this method may be practiced using structures and/or functions other than one or more of the aspects set forth herein.

It should also be noted that the drawings provided in the following embodiments illustrate the basic concept of the present disclosure only in a schematic manner. The drawings show only components relevant to the present disclosure, not drawn according to the actual number, shape, and dimensions of components during implementation. During actual implementation, the type, quantity, and proportion of components may vary arbitrarily. The layout configuration of components may also be more complex.

Additionally, specific details are provided in the following description to facilitate thorough understanding of examples. However, persons skilled in the art will understand that practice may occur without these specific details.

The following describes technical solutions provided by various embodiments of the present disclosure in conjunction with the accompanying drawings.

### Embodiment 1

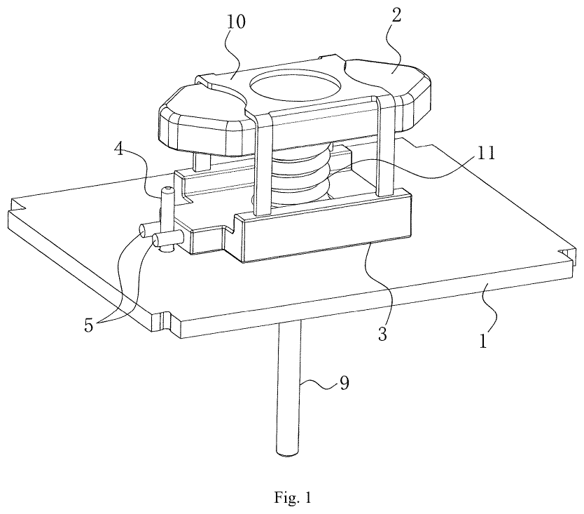

Referring to FIG. 1 to FIG. 4, the present disclosure provides a DC contactor comprising: a magnetic pole piece 1, a pushing rod assembly, and a movable contact plate 2. The magnetic pole piece 1 is formed with a central hole. A push rod 9 of the pushing rod assembly extends through the central hole of the magnetic pole piece 1, and remaining portions of the pushing rod assembly are positioned entirely above the magnetic pole piece 1. The movable contact plate 2 is mounted on the pushing rod assembly. The pushing rod assembly is configured to drive the movable contact plate 2 to move, causing the movable contact plate 2 to contact and separate from fixed contacts of the DC contactor, thereby achieving making and breaking functions of the DC contactor.

Furthermore, in this embodiment, the DC contactor additionally comprises an electromagnetic mechanism, a magnetic circuit portion, and a housing (typically a ceramic cover). The electromagnetic mechanism, the magnetic circuit portion, and the housing all employ conventional prior art techniques and are not shown in the figures. The magnetic pole piece 1, as a component of the magnetic circuit portion, is arranged between the electromagnetic mechanism and the housing. The housing is typically sealed to the magnetic pole piece 1 via a connection ring by welding, enclosing both the pushing rod assembly and the movable contact plate 2. The fixed contacts are fixed to the housing. When the electromagnetic mechanism is energized, the electromagnetic mechanism generates a magnetic field causing a movable iron core within the magnetic circuit portion to move upward and adhere to a stationary iron core. Simultaneously, the movable iron core drives the movable contact plate 2 into contact with the fixed contacts via the pushing rod assembly, thereby conducting the DC contactor. When the electromagnetic mechanism is de-energized, the magnetic field dissipates. Under the combined action of a contact spring 11 and a return spring between the movable iron core and the stationary iron core, the movable iron core is driven downward and pushes the movable contact plate 2 to separate from the fixed contacts via the pushing rod assembly, thereby breaking the DC contactor.

As a critical improvement of the present disclosure, the magnetic pole piece 1 is provided with a first limiting structure; the pushing rod assembly is provided with a second limiting structure; and the first limiting structure and the second limiting structure cooperate to restrict rotational movement of the pushing rod assembly. In the present disclosure, rotational degrees of freedom of the pushing rod assembly are restricted through cooperative interaction between the first limiting structure disposed on the magnetic pole piece 1 and the second limiting structure disposed on the pushing rod assembly. This configuration ensures accurate relative positioning between the movable contact plate 2 and the fixed contact, guaranteeing reliable making and breaking functionality of the DC contactor. The present disclosure abandons conventional approaches providing ceramic ribs within the ceramic cover, thereby avoiding molding difficulties associated with ceramic ribs. This reduces manufacturing process complexity, enhances production efficiency, and improves product yield. Since reliance on ceramic ribs for limitation is eliminated, occupation of internal space within the ceramic cover is significantly reduced. Consequently, the ceramic cover retains ample internal space for arcing and short-circuit protection, enhancing electrical performance reliability of the DC contactor and reducing occurrence risk of arc-related and short-circuit failures. Furthermore, the limiting structure adopted by the present disclosure is not restricted by ceramic molding processes, affording greater design flexibility to better accommodate DC contactors of varying specifications and performance requirements.

Further, the first limiting structure is fixedly and vertically disposed on the magnetic pole piece 1, and adjacent to the second limiting structure. When the pushing rod assembly tends to rotate clockwise or counterclockwise, the first limiting structure abuts against the second limiting structure to restrict rotational movement of the pushing rod assembly.

Notably, a height of the first limiting structure must satisfy the following requirement: throughout a movement stroke of the pushing rod assembly, the second limiting structure continuously forms limiting engagement with the first limiting structure. That is, within the movement stroke of the pushing rod assembly, the second limiting structure never disengages from the first limiting structure. The first limiting structure consistently provides abutment against the second limiting structure, ensuring reliable rotational limitation of the pushing rod assembly.

As shown in FIG. 1, the pushing rod assembly comprises an insulating base 3. The second limiting structure is fixed to the insulating base 3.

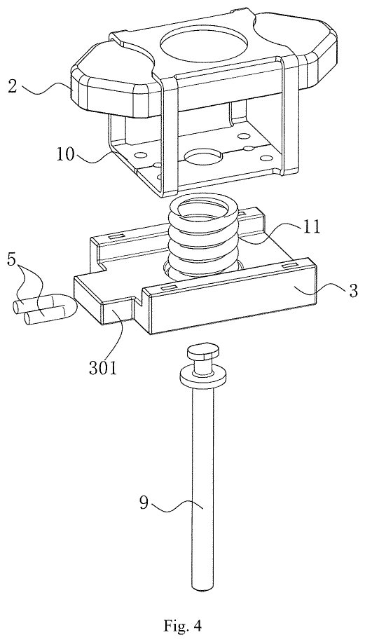

In this embodiment, the second limiting structure comprises two limiting portions 5. The two limiting portions 5 may be integrally formed or separately formed. As shown in FIG. 4, in this embodiment, the two limiting portions 5 are specifically integrally formed. Rear ends of the two limiting portions 5 are connected as a single piece through a U-shaped portion. In this embodiment, the insulating base 3 is formed by injection molding from plastic material. The two limiting portions 5 are fixed to the insulating base 3 by insert molding. The rear ends and U-shaped portion of the two limiting portions 5 are embedded within the plastic, while front ends of the two limiting portions 5 protrude horizontally outward from the insulating base 3 and are spaced apart side by side.

Referring to FIG. 1, the two limiting portions 5 are disposed along a wide-edge side of the insulating base 3. A length direction of the two limiting portions 5 aligns with a length direction of the movable contact plate 2.

Certainly, in other embodiments of the present disclosure, the two limiting portions 5 may alternatively be fixed to the insulating base 3 by plug-in connection, riveting, or using fasteners.

Furthermore, the first limiting structure comprises a limiting member 4. The limiting member 4 may be fixed to the magnetic pole piece 1 by welding, riveting, or threaded fastening.

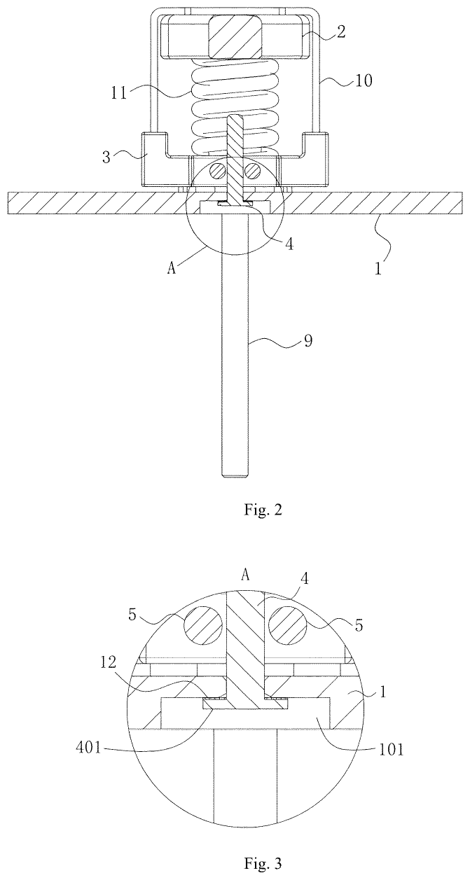

Referring to FIG. 2 and FIG. 3, in this embodiment, the magnetic pole piece 1 is provided with a stepped hole 101 having a small-diameter upper section and a large-diameter lower section. One end of the limiting member 4 extends upward through the stepped hole 101 to protrude above the magnetic pole piece 1 and is positioned between the two limiting portions 5. Another end of the limiting member 4 is hermetically fixed within the stepped hole 101.

When the pushing rod assembly tends to rotate clockwise, a right-side limiting portion 5 on the insulating base 3 abuts against the limiting member 4 to form rotational limitation. Similarly, when the pushing rod assembly tends to rotate counterclockwise, a left-side limiting portion 5 on the insulating base 3 abuts against the limiting member 4 to form rotational limitation.

The present disclosure achieves rotational limitation by fixing the limiting portions 5 in the insulating base 3 of the pushing rod assembly and providing the limiting member 4 on the magnetic pole piece 1. This structure is more robust than prior art and more effectively restricts rotation of the pushing rod assembly. This configuration ensures accurate contact and separation between the movable contact plate 2 and the fixed contacts, guaranteeing reliable making and breaking functionality of the DC contactor. This arrangement eliminates failure of making and breaking functions caused by deviation of the movable contact plate 2.

With continued reference to FIGS. 2-3, the another end of the limiting member 4 is provided with a soldering pad portion 401, preferably circular. A solder sheet 12 is placed between the soldering pad portion 401 and a stepped surface inside the stepped hole 101. The soldering pad portion 401 is hermetically fixed within the stepped hole 101 by brazing, preventing gas leakage at the connection between the magnetic pole piece 1 and the limiting member 4. This ensures gas tightness of the internal space within the housing of the DC contactor.

Referring to FIG. 4, the pushing rod assembly further comprises a push rod 9, a contact holder 10, and a contact spring 11. A bottom of the contact holder 10 is similarly fixed to the insulating base 3 by insert molding and electrically insulated from the limiting portions 5. When the DC contactor is energized, the contact holder 10 is at a high-voltage terminal while the limiting portions 5 are at a low-voltage terminal. Voltage withstand and insulation distance requirements must be satisfied between the contact holder 10 and the limiting portions 5.

Preferably, the present disclosure provides a boss 301 at one end of the insulating base 3. The limiting portions 5 are insert-molded within the boss 301 to satisfy voltage withstand and insulation distance requirements between the contact holder 10 and the limiting portions 5.

Further, the contact holder 10 is frame-shaped. The movable contact plate 2 traverses the contact holder 10. Two ends of the contact spring 11 elastically abut against the movable contact plate 2 and the insulating base 3 respectively. In certain DC contactors with short-circuit withstand capability, for example where a lower armature is disposed below the movable contact plate 2, an upper end of the contact spring 11 elastically abuts against the lower armature. An elastic force applied to the lower armature pushes the movable contact plate 2 upward to abut against a top of the contact holder 10.

In this embodiment, the limiting member 4 and the limiting portions 5 may be made of ceramic or wear-resistant metal materials. Shapes are not limited, including circular, rectangular, etc.

It should be noted that quantities of the first limiting structure and the second limiting structure in the present disclosure are not limited. Provided that mutual rotational limitation of the pushing rod assembly is achieved, appropriate modifications in quantity and position may be made.

### Embodiment 2

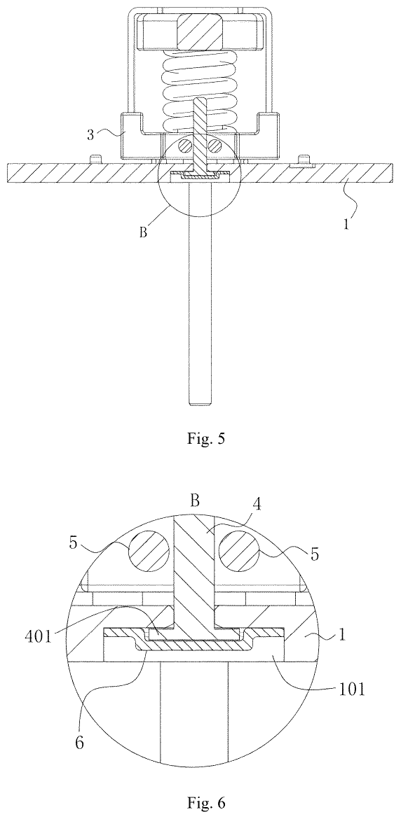

Referring to FIG. 5 and FIG. 6, this embodiment differs from Embodiment 1 in that: the DC contactor further comprises a sealing cover 6, wherein the sealing cover 6 is mounted within the stepped hole 101.

In this embodiment, the sealing cover 6 is U-shaped (inverted-U configuration) and configured to cover the soldering pad portion 401. The sealing cover 6 is hermetically fixed within the stepped hole 101 by laser welding. The present disclosure provides sealing and fixation for the limiting member 4 by arranging the sealing cover 6. Compared with the brazing method in Embodiment 1, laser welding via the sealing cover 6 significantly improves efficiency, facilitates automated welding, and enhances weld strength.

Certainly, in other embodiments of the present disclosure, the sealing cover 6 may be omitted. By modifying dimensions and shape of the soldering pad portion 401 to satisfy requirements for laser welding, direct laser welding may alternatively be employed.

### Embodiment 3

This embodiment differs from Embodiment 1 in that: structures of the first limiting structure and the second limiting structure are distinct.

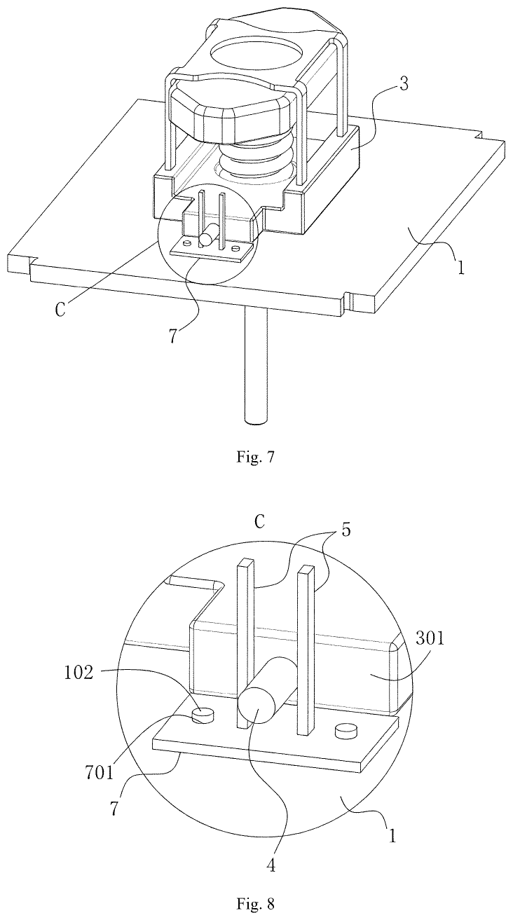

Specifically, referring to FIG. 7 and FIG. 8, in this embodiment, the first limiting structure comprises a limiting seat 7 and two limiting portions 5. The limiting seat 7 is fixed to a top of the magnetic pole piece 1. The two limiting portions 5 are both fixedly disposed vertically on the limiting seat 7 and spaced apart side by side. The two limiting portions 5 may be integrally formed with the limiting seat 7 or separately machined and subsequently fixedly connected.

In this embodiment, the second limiting structure comprises one limiting member 4, wherein the limiting member 4 is oriented horizontally. The limiting member 4 is fixed to the insulating base 3 by insert molding. One end of the limiting member 4 protrudes outward from the insulating base 3 and extends between the two limiting portions 5. In other embodiments of the present disclosure, each of the two limiting members 4 may alternatively be fixed to the insulating base 3 by plug-in connection, riveting, or using fasteners.

When the pushing rod assembly tends to rotate clockwise, the limiting member 4 on the insulating base 3 abuts against a left-side limiting portion 5 to form rotational limitation. Similarly, when the pushing rod assembly tends to rotate counterclockwise, the limiting member 4 on the insulating base 3 abuts against a right-side limiting portion 5 to form rotational limitation.

Referring to FIG. 8, the limiting seat 7 is formed with at least two first through holes 701 (including but not limited to two). A top of the magnetic pole piece 1 is correspondingly provided with two first bosses 102. The two first bosses 102 are inserted into the two first through holes 701 one-to-one and riveted in place. Alternatively, the two first bosses 102 may first be inserted into the two first through holes 701 one-to-one for positioning, followed by fixing the limiting seat 7 to the magnetic pole piece 1 using welding (e.g., laser welding).

Compared with Embodiment 1 or Embodiment 2, this embodiment employs a riveting connection between the limiting seat 7 and the magnetic pole piece 1. This configuration avoids sealing issues resulting from poor welding quality while simplifying assembly.

### Embodiment 4

This embodiment differs from Embodiment 1 in that: structures of the first limiting structure and the second limiting structure are distinct; additionally, the DC contactor of this embodiment further comprises an anti-short-circuit structure.

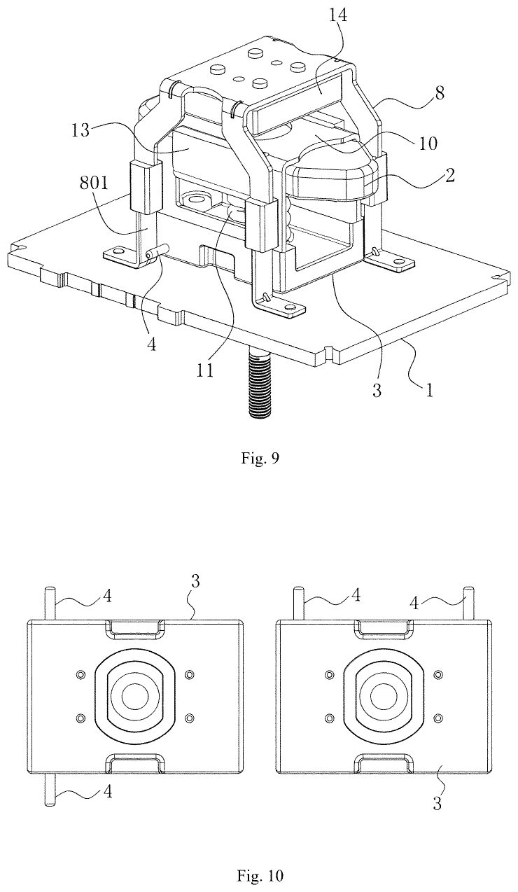

Referring to FIG. 9 and FIG. 10, the anti-short-circuit structure comprises an armature bracket 8, a lower armature 13, and an upper armature 14. The lower armature 13 is U-shaped and engages upward from below with a bottom of the movable contact plate 2. An upper end of the contact spring 11 elastically abuts against the lower armature 13. An elastic force applied to the lower armature 13 pushes the movable contact plate 2 upward to abut against a top of the contact holder 10. The armature bracket 8 is fixed to the top of the magnetic pole piece 1 and overlies an outer side of the pushing rod assembly. The upper armature 14 is fixed to an underside of a top surface of the armature bracket 8 and is spaced opposite to the lower armature 13. When the DC contactor is energized (i.e., the movable contact plate 2 contacts the fixed contacts), current flowing through the movable contact plate 2 generates a magnetic field around the movable contact plate 2. This magnetic field magnetizes both the lower armature 13 and the upper armature 14, generating an attractive force between the lower armature 13 and the upper armature 14. This attractive force acts directly on the movable contact plate 2, increasing contact pressure and enhancing short-circuit withstand capability.

Referring to FIG. 9, the armature bracket 8 is provided with at least four support legs 801 (including but not limited to four) distributed vertically. A bottom of each of the at least four support legs 801 is formed with a flange. Each flange is formed with a second through hole. The second through hole is configured for riveting connection with a second boss disposed on the top of the magnetic pole piece 1, achieving fixation of the armature bracket 8.

In this embodiment, the support legs 801 serve as the first limiting structure. The second limiting structure comprises the limiting member 4, wherein the limiting member 4 is oriented horizontally. The limiting member 4 is fixed to the insulating base 3 by insert molding. One end of the limiting member 4 protrudes outward from the insulating base 3 and is positioned adjacent to the support legs 801. The limiting member 4 cooperates with the support leg 801 to form rotational limitation.

It should be understood that at least two limiting members 4 should be provided. The two limiting members 4 may be integrally connected or separate. As shown in FIG. 10, the two limiting members 4 may be disposed on the same side of the insulating base 3 or on opposite sides of the insulating base 3.

The two limiting members 4 cooperate with two corresponding support legs 801 respectively. When the pushing rod assembly tends to rotate clockwise, one of the limiting members 4 on the insulating base 3 abuts against an adjacent support leg 801 to form rotational limitation. Similarly, when the pushing rod assembly tends to rotate counterclockwise, another one of the limiting members 4 abuts against an adjacent support leg 801 to form rotational limitation.

This embodiment relies on the armature bracket 8 to simultaneously fix the upper armature 14 while directly utilizing the support legs 801 as the first limiting structure. Consequently, compared with Embodiments 1-3, this configuration achieves greater structural simplicity.

### Embodiment 5

Referring to FIG. 11, this embodiment differs from Embodiment 1 or Embodiment 2 in that: the two limiting portions 5 are disposed along a long-edge side of the insulating base 3. A middle portion of the long-edge side of the insulating base 3 is provided with a boss 301. Rear ends and a U-shaped portion of the two limiting portions 5 are embedded within the boss 301. Front ends of the two limiting portions 5 protrude horizontally outward from the boss 301 and are spaced apart side by side. That is, a length direction of the two limiting portions 5 is perpendicular to a length direction of the movable contact plate 2.

### Embodiment 6

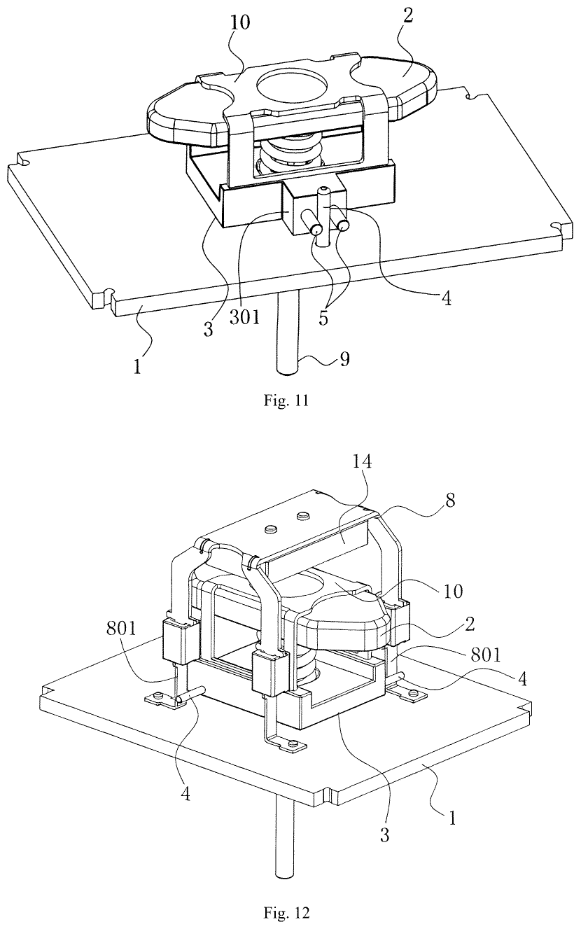

Referring to FIG. 12, this embodiment differs from Embodiment 4 in that: two limiting members 4 are disposed on opposite sides of the insulating base 3 in a diagonal distribution. One of the limiting members 4 is positioned at an inner side of an adjacent support leg 801, while another one of the limiting members 4 is positioned at an outer side of an adjacent support leg 801.

The two limiting members 4 cooperate with two corresponding support legs 801 respectively. When the pushing rod assembly tends to rotate clockwise, the limiting member 4 at the inner side of the support leg 801 abuts against the support leg 801 to form rotational limitation. Similarly, when the pushing rod assembly tends to rotate counterclockwise, the limiting member 4 at the outer side of the support leg 801 abuts against the support leg 801 to form rotational limitation.

### Embodiment 7

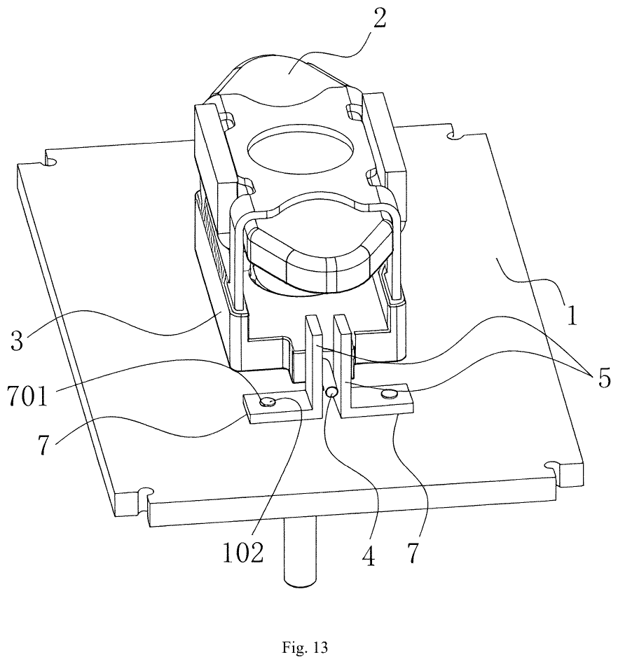

Referring to FIG. 13, this embodiment differs from Embodiment 3 in that: the first limiting structure comprises two limiting seats 7 and two limiting portions 5.

Specifically, the two limiting portions 5 are fixedly disposed on the two limiting seats 7 respectively. In a preferred configuration of this embodiment, each of the limiting portions 5 and its corresponding connected limiting seat 7 are integrally formed as an L-shaped integral structure.

The two limiting seats 7 are fixed to the top of the magnetic pole piece 1. The two limiting portions 5 are vertically fixed on the limiting seats 7 respectively and spaced apart. One end of the limiting member 4 protrudes outward from the insulating base 3 and extends between the two limiting portions 5. When the pushing rod assembly tends to rotate clockwise, the limiting member 4 on the insulating base 3 abuts against a left-side limiting portion 5 to form rotational limitation. Similarly, when the pushing rod assembly tends to rotate counterclockwise, the limiting member 4 on the insulating base 3 abuts against a right-side limiting portion 5 to form rotational limitation.

Each of the limiting seats 7 is formed with at least one first through hole 701. The top of the magnetic pole piece 1 is correspondingly provided with at least two first bosses 102. The first bosses 102 are inserted into the first through holes 701 and riveted in place. Alternatively, the first bosses 102 may first be inserted into the first through holes 701 for positioning, followed by fixing the limiting seats 7 to the magnetic pole piece 1 using welding (e.g., laser welding).

In summary, the DC contactor of the present disclosure restricts rotational degrees of freedom of the pushing rod assembly through cooperative interaction between the first limiting structure disposed on the magnetic pole piece 1 and the second limiting structure disposed on the pushing rod assembly. This configuration ensures accurate relative positioning between the movable contact plate 2 and the fixed contact, guaranteeing reliable making and breaking functionality of the DC contactor. The present disclosure abandons conventional approaches providing ceramic ribs within the ceramic cover, thereby avoiding molding difficulties associated with ceramic ribs. This reduces manufacturing process complexity, enhances production efficiency, and improves product yield. Since reliance on ceramic ribs for limitation is eliminated, occupation of internal space within the ceramic cover is significantly reduced. Consequently, the ceramic cover retains ample internal space for arcing and short-circuit protection, enhancing electrical performance reliability of the DC contactor and reducing occurrence risk of arc-related and short-circuit failures. Furthermore, the limiting structure adopted by the present disclosure is not restricted by ceramic molding processes, affording greater design flexibility to better accommodate DC contactors of varying specifications and performance requirements.

Identical or similar parts between embodiments in this specification may be cross-referenced. Each embodiment emphasizes differences from other embodiments.

The foregoing describes only specific embodiments of the present disclosure. However, the scope of protection of the present disclosure is not limited thereto. Any modification or substitution readily conceivable by persons skilled in the art within the technical scope disclosed in the present disclosure shall fall within the scope of protection of the present disclosure. Therefore, the scope of protection of the present disclosure shall be governed by the scope of the claims.

What is claimed is:

1. A Direct Current (DC) contactor, comprising a magnetic pole piece, a pushing rod assembly penetrating through the magnetic pole piece, and a movable contact plate mounted on the pushing rod assembly; wherein
the pushing rod assembly is configured to drive the movable contact plate to move for making or breaking contact of the DC contactor;
the magnetic pole piece is provided with a first limiting structure;
the pushing rod assembly is provided with a second limiting structure; and
the first limiting structure and the second limiting structure cooperate to restrict rotational movement of the pushing rod assembly.

2. The DC contactor according to claim 1, wherein
the first limiting structure is fixedly and vertically disposed on the magnetic pole piece, and adjacent to the second limiting structure; and
when the pushing rod assembly tends to rotate clockwise or counterclockwise, the first limiting structure and the second limiting structure mutually abut to restrict the rotational movement of the pushing rod assembly.

3. The DC contactor according to claim 2, wherein a height of the first limiting structure is such that: throughout a movement stroke of the pushing rod assembly, the second limiting structure continuously forms a limiting engagement with the first limiting structure.

4. The DC contactor according to claim 2, wherein the pushing rod assembly comprises an insulating base; and the second limiting structure is fixed to the insulating base.

5. The DC contactor according to claim 4, wherein the first limiting structure is fixed to the magnetic pole piece by welding, riveting or threaded fastening; and
the second limiting structure is fixed to the insulating base by any one of integral molding, plug-in connection, riveting or using a fastener.

6. The DC contactor according to claim 4, wherein one of the first limiting structure and the second limiting structure comprises at least one limiting member; and
another of the first limiting structure and the second limiting structure comprises at least two limiting portions distributed on two sides of the at least one limiting member.

7. The DC contactor according to claim 6, wherein the first limiting structure comprises a limiting member;
the magnetic pole piece is provided with a stepped hole having a small-diameter upper section and a large-diameter lower section;
one end of the limiting member extends upward through the stepped hole to protrude above the magnetic pole piece;
another end of the limiting member is hermetically fixed within the stepped hole;
the second limiting structure comprises two integrally formed or separate limiting portions;
the two limiting portions protrude outward from the insulating base and are spaced apart side by side; and
the limiting member is located between the two limiting portions.

8. The DC contactor according to claim 7, wherein the another end of the limiting member is provided with a soldering pad portion, and the soldering pad portion is hermetically fixed within the stepped hole by brazing or laser welding; or
the soldering pad portion is covered with a sealing cover, and the sealing cover is hermetically fixed within the stepped hole by brazing or laser welding.

9. The DC contactor according to claim 6, wherein
the first limiting structure comprises at least one limiting seat and at least two limiting portions fixedly disposed on the limiting seat;
the limiting seat is provided with a first through hole;
a top of the magnetic pole piece is provided with a first boss, and the first boss is inserted into the first through hole and riveted in place;
the second limiting structure comprises at least one limiting member; and
the limiting member is located between the two limiting portions.

10. The DC contactor according to claim 4, further comprising an armature bracket, wherein
the armature bracket is fixed to a top of the magnetic pole piece and overlies an outer side of the pushing rod assembly;
the armature bracket is provided with a support leg, and the support leg serves as the first limiting structure;
the second limiting structure comprises a limiting member adjacent to the support leg; and
the limiting member cooperates with the support leg to form a rotational limitation.
